(19) United States
(12) Patent Application Publication
(10) Pub. No.: US 2026/0125258 A1
(43) Pub. Date: May 7, 2026

(54) PROBE SAVER

(71) Applicant: Scott Vernon Giese, Blanco, TX (US)

(72) Inventor: Scott Vernon Giese, Blanco, TX (US)

(21) Appl. No.: 19/377,598

(22) Filed: Nov. 3, 2025

Related U.S. Application Data
(60) Provisional application No. 63/717,184, filed on Nov. 6, 2024.

(51) Int. Cl. B66F 19/00; G01F 23/30

(52) U.S. Cl. CPC B66F 19/00; G01F 23/30

(57) ABSTRACT

A probe saver system includes a safety cable having an upper and lower portion with a holder therebetween, the safety cable upper portion having a lifting loop distal to the holder and the safety cable lower portion having first and second branches connected at the first holder with the safety cable upper portion. The probe saver system also includes a mount connected to the safety cable's branches distal to the holder and configured for attaching to an ATG assembly, wherein the mount configuration permits the ATG assembly to be positioned in a riser and a liquid storage tank with the safety cable and the mount attached to the ATG assembly.

### CROSS REFERENCE TO RELATED APPLICATION

This application hereby incorporates herein by reference and claims benefit of the priority date of U.S. provisional patent application 63/717,184, which has a filing date of 6 Nov. 2024.

### TECHNICAL FIELD

This invention relates to petroleum storage tanks, and more particularly to installation and removal of automatic tank gauge assemblies.

### BACKGROUND

Automatic Tank Guage (“ATG”) systems have been used for many years to monitor storage tanks for leaks and liquid levels, including tanks in the convenience store and petroleum storage industries. Such ATG systems include in-tank ATG assemblies having probes and data cables (also referred to herein as “communication cables”) that attach to the respective probes. There are millions of ATG assemblies currently installed in tanks across the nation and other countries.

### SUMMARY

A probe saver system includes a safety cable having an upper and lower portion with a holder therebetween, the safety cable upper portion having a lifting loop distal to the holder and the safety cable lower portion having first and second branches connected at the first holder with the safety cable upper portion.

The probe saver system also includes a mount connected to the safety cable's branches distal to the holder and configured for attaching to an ATG assembly, wherein the mount configuration permits the ATG assembly to be positioned in a riser and a liquid storage tank with the safety cable and the mount attached to the ATG assembly.

In another aspect, the mount configuration includes the mount being configured for attaching to a probe body of the ATG assembly

In another aspect, a data cable is connected to the probe body via a fitting, the probe body having a threaded barrel for screwing into matching threads of an opening in the fitting, wherein the mount configuration includes the mount forming a central opening having a diameter large enough to receive the barrel so that the central opening allows the mount to be positioned around the barrel.

In another aspect, the fitting has an outer diameter and the mount configuration includes the mount being thinner than the threaded length of the barrel and the diameter of the mount's central opening being smaller than the outer diameter of the fitting to enable i) positioning the mount around the barrel while being between the probe body and the fitting and ii) holding the mount tightly against the probe body with the fitting screwed in tightly.

In an alternative, a data cable is connected to the probe body via a fitting, the fitting having a threaded barrel for screwing into matching threads of an opening in the probe body, wherein the mount configuration includes the mount forming a central opening having a diameter large enough to receive the barrel so that the central opening allows the mount to be positioned around the barrel.

In this alternative, as well, the fitting has an outer diameter and the mount configuration includes the mount being thinner than the threaded length of the barrel and the diameter of the mount's central opening being smaller than the outer diameter of the fitting to enable i) positioning the mount around the barrel while being between the probe body and the fitting and ii) holding the mount tightly against the probe body with the fitting screwed in tightly.

Details of one or more embodiments of the disclosure are set forth in the accompanying drawings and the description below. Other forms, features, objects, and advantages of the present invention will be apparent from the description, drawings, and claims.

### DESCRIPTION OF DRAWINGS

FIG. 1 provides an elevation view of an ATG system with a probe saver system installed in a storage tank, as configured in accordance with embodiments of the present disclosure.

FIG. 2 shows details of a portion of FIG. 1, wherein a riser pipe with an installed ATG assembly and probe saver system are shown in more detail, as configured in accordance with embodiments of the present disclosure.

FIG. 3 provides an elevation view showing more details of the probe saver system of FIGS. 1 and 2, as configured in accordance with an embodiment of the present disclosure.

FIG. 4 provides a top view of the probe saver system's mount of FIG. 3, as configured in accordance with an embodiment of the present disclosure.

FIG. 5 provides an elevation view showing more details of the probe saver system of FIGS. 1 and 2, as configured in accordance with an embodiment of the present disclosure that includes an alternative to the probe saver system's mount of FIG. 3.

### DETAILED DESCRIPTION

The probe saver system and method disclosed herein was developed out of an industry need to prevent chronic failure of ATG systems. The present invention involves study leading to recognition of a problematic combination of equipment, circumstances, causes and effects, including the following: i) ATG assemblies, including their probes, have historically been installed in or removed from tanks by manually using their respective data cables, themselves, to support weight of the ATG assemblies when lowering them into or raising them from storage tanks, ii) the most common failure points of ATG systems include these data cables, iii) this way of lowering or raising an ATG assembly causes undue stress on its data cable and the data cable's point of connection to electronics in its probe body, which tends to contribute to data communication failure, iv) the more times an ATG assembly is raised or lowered this way, the higher the failure rate of its data communication, and v) ATG assemblies are regularly removed from, and then restored to, their monitoring positions in storage tanks for regulatory demands or maintenance and other servicing of the tanks or ATG systems.

Embodiments of the present disclosure provide a lifting system and stress relief method alleviating the failure described hereinabove. According to the system and method, a Prove Saver system is attached to an ATG assembly, which may then be lifted and lowered by the attached Prove Saver system instead of by its data cable. Aspects of the herein disclosed probe saver system are suited for installing on new or existing ATG assemblies by persons familiar with ATG systems. It is advantageous that they may do so using simple hand tools. This probe saver system is suited for distribution to petroleum supply companies, tank installers, fuel jobbers, and even probe suppliers.

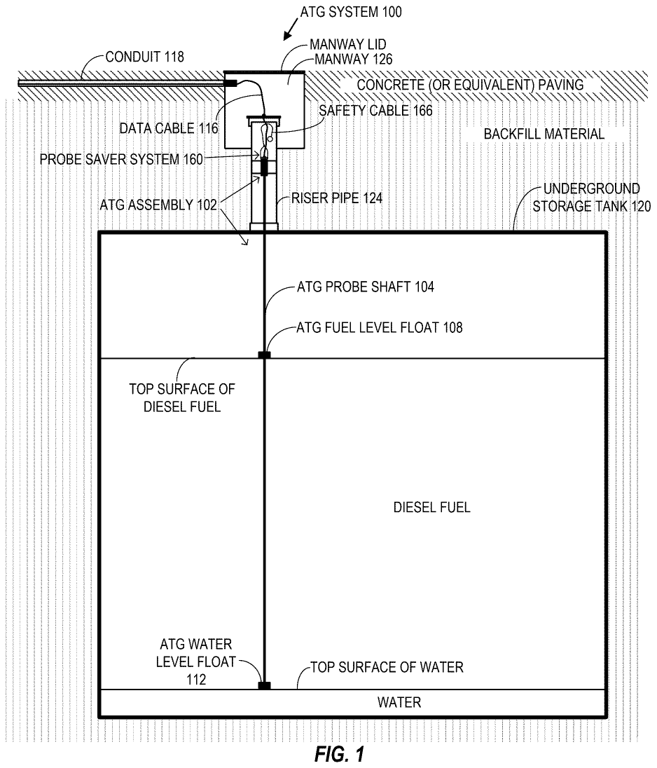

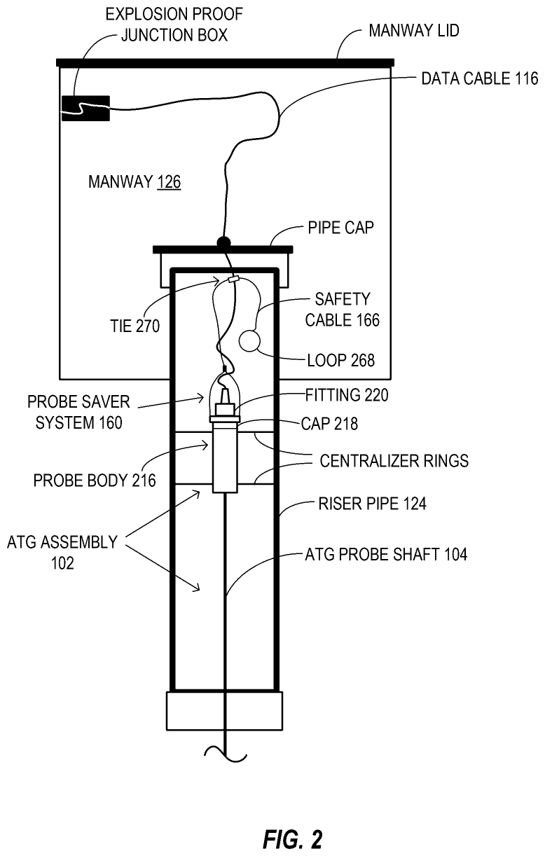

Referring now to FIG. 1, ATG system 100 is shown within a liquid storage tank 120, which is underground in the illustrated instance, wherein ATG system 100 includes an ATG assembly 102 that is commercially available from various vendors, including Veeder-Root, for example. As shown in FIG. 1, ATG assembly 102 is installed through manway 126 and riser 124 for a liquid storage tank 120, wherein ATG assembly 102 includes a probe body (element 216 in FIG. 2), centralizer (element 214 in FIG. 2), a probe shaft 104, a fuel level float 108, and a water level float 112. Once installed, probe body 216 of ATG assembly 102 is within riser pipe 124 and a data cable 116 of ATG system 100 extends from probe body 216 up through riser pipe 124 and manway 126 and then through conduit 118 to communicate with a remote device (not shown), which may be part of ATG system 100. Probe saver system 160 is configured for securely attaching to ATG assembly 102, as shown, so that assembly 102 may be raised and lowered within or through riser pipe 124 by safety cable 166 of system 160. Probe saver system 160 provides an alternative to data cable 116 for supporting weight of ATG assembly 102 as assembly 102 is raised from and lowered into tank 120.

Referring now to FIG. 2, a more detailed view is shown of manway 126 and riser pipe 124 with installed ATG assembly 102 and probe saver system 160, according to an embodiment of the present disclosure. As previously stated in the above description of FIG. 1, system 160 is affixed to ATG assembly 102. More specifically, safety cable 166 of system 160 may be affixed to probe body 216 of ATG assembly 102, as shown in FIG. 2. Probe body 216 may include a transmitter (not shown) connected to data cable 116 via pins (not shown) on cable 116 and a socket (not shown) in probe body 216, where data cable 116 is routed through cap 218 of probe body 216 via fitting 220 in cap 218, such as a compression fitting containing a compressible material that may be referred to as a grommet, bushing or seal, for example, for providing a seal around cable 116. Before or after ATG assembly 102 is installed in riser 124 and tank 120, tie 270 may be added to system 160 for connecting safety cable 166 to data cable 116. In an embodiment of the present disclosure, data cable 116 may be provided as part of probe saver system 160. Also, fitting 220 may be provided as part of probe saver system 160.

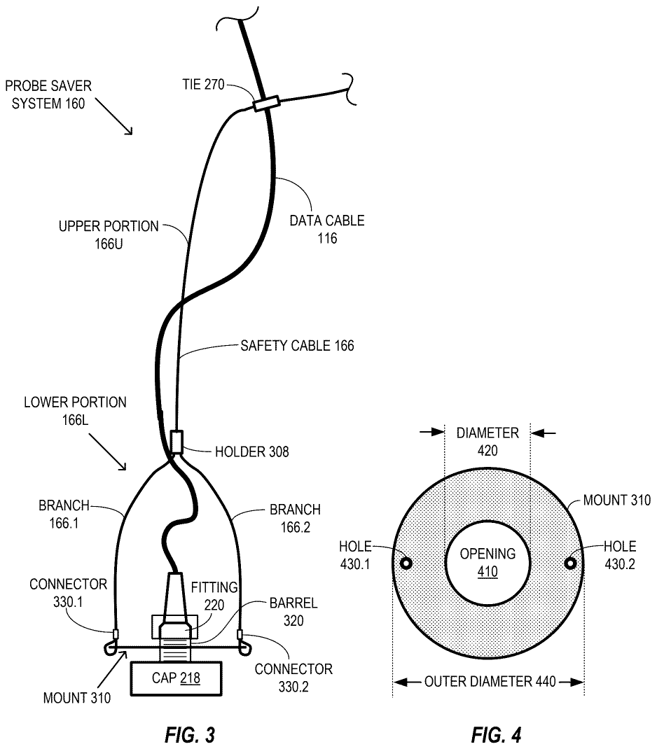

Referring now to FIG. 3, safety cable 166 has an upper portion 166U and a lower portion 166L in this disclosed embodiment, wherein lower portion 160L has first and second branches 166.1 and 166.2. Between safety cable 166 upper portion 166U and lower portion 166L, system 160 includes a holder 308 for holding first and second branches 166.1 and 166.2 together. (Holder 308 may also be for holding together safety cable 166 upper portion 166U and lower portion 166L. Alternatively, safety cable 166 upper portion 166U and lower portion 166L may be continuous.) Holder 308 may be a crimp connector, a fused connector, set screw connector, a clamp, or a tie, for example. System 160 further includes, distal to holder 308 on safety cable 166 lower portion 166L, a mount 310 configured to securely connect probe saver system 160 to ATG assembly 102.

One aspect of how mount 310 is configured to connect probe saver system 160 to ATG assembly 102 includes the following, for example. Threaded barrel 320 of cap 218 screws into matching threads of an opening in fitting 220, which is shown partly unscrewed in the illustrated instance. (Alternatively, fitting 220 has a threaded barrel instead of cap 218. In this alternative the barrel screws into matching threads of an opening in cap 218.) Referring now to FIG. 4 together with FIG. 3, mount 310 forms a central opening 410 having a diameter 420 that is large enough to receive barrel 320 so that central opening of mount 310 may be positioned around barrel 320, as shown. Mount 310 is thin relative to the threaded length of barrel 320 and diameter 420 is smaller than the outer diameter of fitting 220. Accordingly, when mount 310 is around barrel 320 it may be positioned between cap 218 and fitting 220 as shown, such that fitting 220 tightens against mount 310 when fitting 220 is screwed in sufficiently on barrel 320. In response, mount 310 tightens against cap 218 so that fitting 220 and mount 310 are held tightly in cap 218 when fitting 220 is screwed in tightly.

Another aspect of how mount 310 is configured to connect probe saver system 160 to ATG assembly 102 includes the following. Mount 310 forms holes 430.1 and 430.2 somewhat larger than the diameter of cable 166 branches 166.1 and 166.2, where holes 430.1 and 430.2 are near the edges of outer diameter 440, which is somewhat larger than the outer diameter of cap 218. Accordingly, ends of branches 166.1 and 166.2 are inserted in holes 430.1 and 430.2, respectively, folded back and attached by connectors 330.1 and 330.2 to respective branches 166.1 and 166.2, themselves, such as by crimp connectors, fused connectors, set screw connectors, clamps or ties, for example. In this way, for example, mount 310 is connected to first and second branches 166.1 and 166.2 distal to holder 308. Thus, system 160 is secured to ATG assembly 102 with fitting 220 and mount 310 held tightly on cap 218 and with mount 310 connected to first and second branches 166.1 and 166.2.

In other aspects, FIG. 3 more clearly shows that lifting loop 168 of probe saver system 160 is attached to cable 166 upper portion 166U above holder 308 such as, for example, at an end of upper portion 166U distal to device 308, as shown. As previously stated, probe saver system 160 may include tie 270 that ties safety cable upper portion 166U to data cable 116 in riser 124. (It should be understood that “tie” herein encompasses a variety of connections, which may be selected from among those including a crimp connector, fused connector, set screw connector and clamp, for example.) FIG. 3 more clearly shows that tie 270 is at location on safety cable upper portion 166U, i.e., above holder 308, and near lifting loop 168 to hold loop 168 readily accessible by a user. More specifically, tie 270 is at a location on data cable 116 where data cable 116 includes slack therebelow such that that that with ATG assembly 102 installed the user may pull data cable 116 upward from manway 126 to raise loop 168 to within reach without pulling data cable 116 taut below tie 270. Still more particularly, tie 270 is at a location on data cable 116 where data cable 116 includes enough slack such that some slack still remains even with the upper and lower portions 166U and 166L of safety cable 166 pulled taut from safety cable 166 supporting weight of tank gauging assembly 102 when using safety cable 166 for raising and lowering tank gauging assembly 102, as shown in FIG. 3. This slack is so that safety cable 166 is the sole support of ATG assembly 102 when it is being raised and lowered, i.e., there is no ATG assembly 102 weight supported by data cable 116 even with safety cable 166 pulled taut. With tie 270 in the above-described positions relative to data cable 116 and safety cable 166, lifting loop 168 is accessible for grasping and probe saver system 160 provides an alternative to data cable 116 for supporting weight of ATG assembly 102.

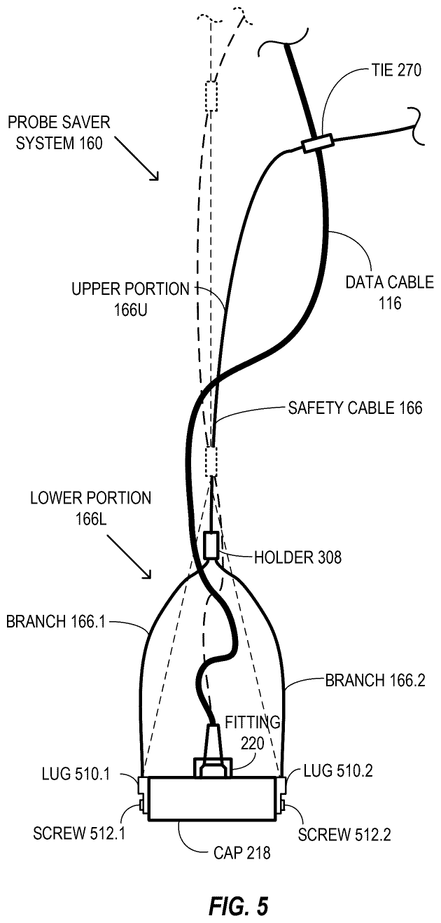

Referring now to FIG. 5, first and second lugs 310.1 and 310.2 provide a different mount than mount 310 of FIG. 3. Lugs 310.1 and 310.2 are connected to respective ends of branches 166.1 and 166.2, as shown, and may include crimp, fused or set screw connectors, for example, to attach to branches 166.1 and 166.2 by crimping, fusing, or bolting. Lugs 310.1 and 310.2 are attached by respective screws or bolts 312.1 and 312.2 to cap 218 of probe body 216.

The present disclosure includes a method of providing probe saver system 160, according to an embodiment, as may be understood from the foregoing.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing measurements of length, etc., quantities of ingredients, reaction conditions, and so forth used in the specification and claims are to be understood as being modified in all instances by the term “about. ” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

A number of embodiments of the disclosure have been described. Nevertheless, it will be understood that various modifications may be made without departing from the spirit and scope of the disclosure. The safety cable may be 0.0165″ diameter stainless steel, stranded cable, factory coated with a coating resistant to substances stored in the tank. However, the probe saver may be constructed of other cable sizes and materials or of suitable rope, wire or other material while still remaining within the scope of the present invention. Several types of connections are described herein for affixing probe saver system 160 to ATG assembly 102 but it should be understood that other types may be used while still remaining within the scope of the present invention.

What is claimed is:

1. A probe saver system comprising:
a safety cable having an upper and lower portion with a holder therebetween, the safety cable upper portion having a lifting loop distal to the holder and the safety cable lower portion having first and second branches connected at the first holder with the safety cable upper portion; and
a mount connected to the safety cable's branches distal to the holder and configured for attaching to an automatic tank gaging (ATG) assembly, wherein the mount configuration permits the ATG assembly to be positioned in a riser and a liquid storage tank with the safety cable and the mount attached to the ATG assembly.

2. The probe saver system of claim 1, wherein the mount configuration includes the mount being configured for attaching to a probe body of the ATG assembly.

3. The probe saver system of claim 2, wherein a data cable is connected to the probe body via a fitting, the probe body having a threaded barrel for screwing into matching threads of an opening in the fitting, and wherein the mount configuration includes the mount forming a central opening having a diameter large enough to receive the barrel so that the central opening allows the mount to be positioned around the barrel.

4. The probe saver system of claim 3, wherein the fitting has an outer diameter and the mount configuration includes the mount being thinner than the threaded length of the barrel and the diameter of the mount's central opening being smaller than the outer diameter of the fitting to enable i) positioning the mount around the barrel while being between the probe body and the fitting and ii) holding the mount tightly against the probe body with the fitting screwed in tightly.

5. The probe saver system of claim 2, wherein a data cable is connected to the probe body via a fitting, the fitting having a threaded barrel for screwing into matching threads of an opening in the probe body, and wherein the mount configuration includes the mount forming a central opening having a diameter large enough to receive the barrel so that the central opening allows the mount to be positioned around the barrel.

6. The probe saver system of claim 5, wherein the fitting has an outer diameter and the mount configuration includes the mount being thinner than the threaded length of the barrel and the diameter of the mount's central opening being smaller than the outer diameter of the fitting to enable i) positioning the mount around the barrel while being between the probe body and the fitting and ii) holding the mount tightly against the probe body with the fitting screwed in tightly.
